(19) United States
(12) Patent Application Publication
(10) Pub. No.: US 2011/0210563 A1
(43) Pub. Date: Sep. 1, 2011

(54) PERMANENT MAGNET GENERATOR

(76) Inventor: Sung Sik Yang, Seoul (KR)

(21) Appl. No.: 12/672,895

(22) PCT Filed: Sep. 17, 2007
(86) PCT No.: PCT/KR2007/004470

§ 371 Date: Feb. 9, 2010

(30) Foreign Application Priority Data
Aug. 21, 2007 (KR) 10-2007-0083974

(51) Int. Cl. F03G 5/06; H02K 1/27

(52) U.S. Cl. 290/1 R; 310/156.43; 290/50

(57) ABSTRACT

The present invention relates to a permanent magnet generator for increasing the capacity of generating the electric power by increasing the number of a magnetic pole. Thus, the present invention is constructed to largely increase the capacity of generating the electric power by installing the ferromagnetic substances, which are magnetized due to permanent magnets disposed at the rotor, between the permanent magnets thereby easily increasing the number of the magnetic poles twice.

### TECHNICAL FIELD

The present invention relates to a permanent magnet generator, and more particularly, to a permanent magnet generator, which has ferromagnetic substances for increasing the number of the magnetic poles of the rotor more than twice so as to improve the capacity of generated electric power.

### BACKGROUND ART

In general, a permanent magnet generator is a generator, which obtains necessary magnetic flux by using a permanent magnet, and has advantages that it has a higher efficiency than a winding type generator, and can be minimized.

However, as it was constructed to directly install a magnetic pole to the rotor, it was very difficult to install or separate the magnetic pole from the rotor because of the repulsion force or the suctioning force produced between the magnetic poles. Also, as the magnetic pole should be machined to form a round shape due to the structure of the rotor, a problem occurred that a magnet for constituting a round magnetic pole is expensive.

In addition, it is required to manufacture the magnet to be larger to increase the capacity of generating the electric power, however, it is ineffective because a large quantity of energy is required to magnetize the large magnet.

Moreover, when the generation of the electric power is required at a place where the rotation movement is small, the electricity is obtained by subjecting a generator with a few magnetic poles to a chain or a gear, and the like, however, it was difficult to obtain desired quantity of generation of the electric power, because a loss at a power transmission device for driving the generator was high.

This problem could be easily understood by the consideration of cases such as manpower or a wind generator, and the like, in which output energy is less than input energy.

Accordingly, it is required to increase frequency (f), or a winding number (N), or magnetic flux (φ) in a voltage equation as denoted by V=4.44 f Nφ[V] so as to increase the voltage of the generator. However, when the rotation for the generation of the electric power becomes smaller, the frequency becomes smaller so that it is required to increase the winding number (N) or the magnetic flux (φ), then, when the winding number (N) becomes more, resistance or reluctance becomes larger, thereby increasing the voltage reduction, so that it is necessary to increase the magnetic flux (φ).

Thus, it is required to make the magnet large to increase the magnetic flux while the magnet made of rare-earth substance is used. In this regard, when the magnet becomes large, several problems can be occurred in the treatment of the magnet. In other words, as described above, as the magnet becomes larger, more magnetic energy will be consumed, and it becomes more difficult to separate the magnets after they are adhered, as the suctioning force produced between the magnets becomes smaller due to their large size. As a result, it is preferable to transport the magnets after installing them to the rotor. However, it is difficult to install the magnets at the rotor in such a manner as to be spaced apart from each other by a predetermined interval, and it becomes also difficult to install the magnets in such a manner as to be spaced apart from each other by a predetermined interval during the manufacturing of the generator.

### DISCLOSURE OF INVENTION

### Technical Problem

Accordingly, the present invention was devised to solve such conventional problems, and an object of the present invention is to provide a permanent magnet generator, which can install ferromagnetic substances having an easily magnetizing property between the permanent magnets to increase the number of the magnetic poles, which is installed at the rotor, thereby producing larger electric power to accomplish an economic efficiency.

### Technical Solution

To achieve the above object, the present invention provides a permanent magnet generator comprising: a rotor constructed by installing permanent magnets at an outer peripheral edge thereof in such a manner as to be spaced apart from each other by a predetermined interval so that identical magnetic poles of the permanent magnets face each other; ferromagnetic substances, each of which is made of magnetizing metal substance and installed between the permanent magnets of the rotor so that they can be magnetized to be the same magnetic poles as those of the permanent magnets; and a stator constructed to enclose the rotor by winding coils for inducting electric current between the ferromagnetic substances and the permanent magnets.

In addition, the permanent magnet generator of the present invention is characterized in that non-magnetic substances are installed in the axial direction of the rotor, and the permanent magnets are arranged on the non-magnetic substances in series along the axial direction of the rotor.

Also, the permanent magnet generator of the present invention is characterized by further including a rotation means for rotating the rotor.

Moreover, the permanent magnet generator of the present invention is characterized in that the rotation means is a pedal installed at a shaft of the rotor so that it can be treaded with feet.

In addition, the permanent magnet generator of the present invention is characterized in that the stator is provided with a battery for accumulating the electricity produced from the coils.

### Advantageous Effects

Therefore, according to the permanent magnet generator of the present invention, it is possible to obtain an advantage of achieving the economic efficiency of obtaining larger capacity of generating the electric power by the structure of increasing the number of the magnetic poles more than twice because magnetized ferromagnetic substances are installed between the permanent magnets disposed at the rotor.

### BRIEF DESCRIPTION OF THE DRAWINGS

FIG. 1 is a schematic view showing a portion of a permanent magnet generator according to an embodiment of the present invention;

FIG. 2 is a schematic view showing only a portion of the permanent magnet generator according to another embodiment of the present invention;

FIG. 3 is a schematic view showing a portion of the permanent magnet generator according to still another embodiment of the present invention;

FIG. 4 is a view schematically showing an arrangement of magnets according to still another embodiment of the present invention;

FIG. 5 is a view showing a use example of the permanent magnet generator according to the present invention; and

FIG. 6 is a view showing another use example of FIG. 5.

### MODE FOR THE INVENTION

Hereinafter, the preferred embodiment of the present invention will be described in detail with reference to the appended drawings.

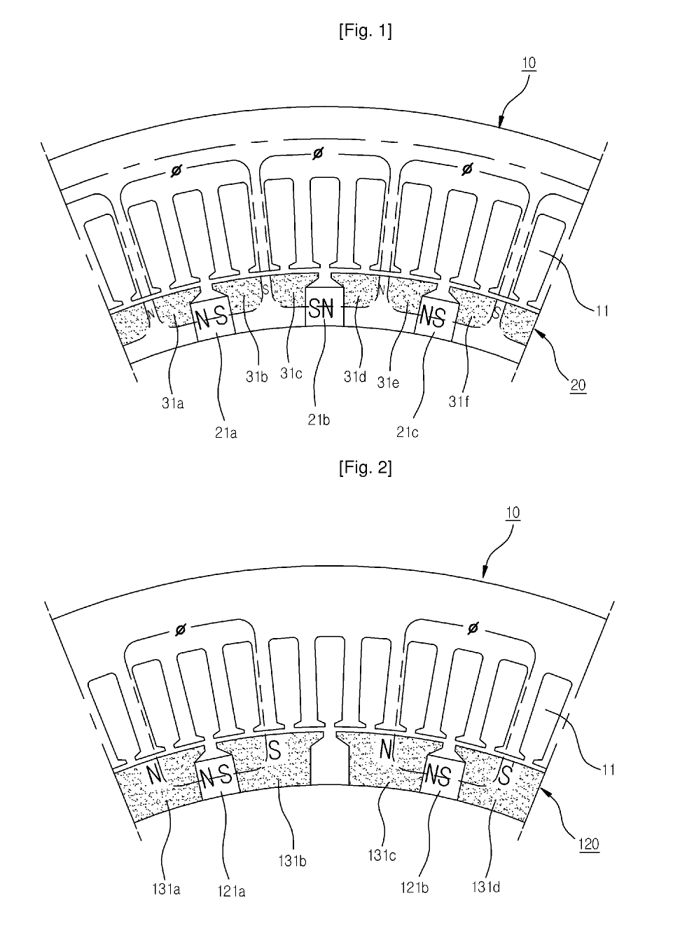

FIG. 1 is a schematic view showing a portion of a permanent magnet generator according to an embodiment of the present invention. As shown in FIG. 1, the permanent magnet generator according to the present invention comprises a stator 10 wound with coils (not shown) and a rotor 20.

The stator 10 is shown as formed with a plurality of slots 11 at an inner peripheral edge with a predetermined interval so that coils can be wound around it through the slots 11, however, the stator 10 can be wound with the coils by using a magnetic induction core, differently from this case.

Thus, the rotor 20 is installed at the inside of the stator 10, and a plurality of magnets 21a, 21b, 21c are installed at an outer peripheral edge.

In addition, a plurality of ferromagnetic substances 31a, 31b, 31c, 31d, 31e, 31d, 31f is installed between the permanent magnets 21a, 21b, 21c so that they are magnetized to form new magnetic poles. The permanent magnets 21a, 21b, 21c are installed in a predetermined interval so that identical magnetic pole can be opposite to each other. As a result, the ferromagnetic substances 31a, 31b, 31c, 31d, 31e, 31f are magnetized to be the same polarities as those of the permanent magnets to form new magnetic poles.

More concretely speaking, at first, the ferromagnetic substances 31a, 31b, 31c, 31d are installed at the outer peripheral edge of the rotor 20 with a predetermined interval. Then, the permanent magnet 21a and the permanent magnet 21c are installed by being inserted between the ferromagnetic substance 31a and the ferromagnetic substance 31b, and between the ferromagnetic substance 31e and the ferromagnetic substance 31f with the N pole directing toward the left side, without inserting any ferromagnetic substance between the ferromagnetic substance 31c and the ferromagnetic substance 31d. Then, the ferromagnetic substances 31a, 31e positioned at the left side with interposing the permanent magnets 21a, 21c are magnetized to be N poles by the effect of the N poles of the permanent magnets 21a, 21c, and the ferromagnetic substances 31b, 31f positioned at the right side are magnetized to be S poles by the effect of the S poles of the permanent magnets 21a, 21c.

In this instance, when the permanent magnet 21b is inserted between the ferromagnetic substance 31c and the ferromagnetic substance 31d with the S pole facing toward the left side, the ferromagnetic substances 31a, 31b, 31c, 31d are magnetized to be the same polarities as those of the left and right sides of the permanent magnets 21a, 21b, 21c thereby forming new magnetic poles.

While repulsion force is produced due to the ferromagnetic substance 31b magnetized to be the S pole and the ferromagnetic substance 31e magnetized to be the N pole, when the permanent magnet 21b is inserted between the ferromagnetic substance 31c and the ferromagnetic substance 31d, it was not difficult to assembly the permanent magnets because the repulsion force produced between the ferromagnetic substances at this time is less than that produced between the permanent magnets. Thus, while it is almost impossible to assemble magnets themselves so that identical magnetic poles face each other, it can be easily assembled by disposing the ferromagnetic substances 31a, 31b, 31c, 31d, 31e, 31f as mediums. As a result, it is possible to obtain high voltage at low speed, because a flux density on the pole increases by the assembly.

The stator 10 generates electric power according to the Lenz s Law and the Fleming s Law through the interaction between the ferromagnetic substances 31a, 31b, 31c, 31d, 31e, 31f magnetized by the rotation of the rotor 20 and the permanent magnets 21a, 21b, 21c.

Accordingly, the number of magnetic poles was conventionally decided based on the number of the magnets, however, the number of magnetic poles are decided based on twice the number of the magnets according to the present invention because all of the two magnetic poles of the magnets become to be the number of the magnetic poles, so that frequency is increased to be twice thereby producing larger electric power.

According to the structure of the present invention as described above, it is possible to easily increase the capacity of generating the electric power by only increasing the number of the magnets and inserting the ferromagnetic substances into the slots of the rotor thereby lengthening the length of the rotor to achieve the increase of the magnetic flux.

Also, since the magnet can be manufactured to be a stick shape according to the present invention, the manufacturing cost of the product can be reduced. In addition, while the magnetic reduction of the magnet is produced due to outer accident, since it can be complemented by the magnetic poles (i.e., magnetized ferromagnetic substance), the effect of the magnetic reduction of the magnet itself becomes very little.

Moreover, it is preferable to connect a battery (not shown) to coils of the stator 10 to accumulate the electric power. The battery accumulates the electric power produced at the coils of the stator 10 and it is supplied stably to the use place. The accumulated electricity is transformed into DC or AC so that it can be used house-hold electric devices, and the like.

FIG. 2 is a view schematically showing a portion of the permanent magnet generator according to another embodiment of the present invention, in which identical numerals are denoted for the identical portions so as to avoid repeated explanations.

As shown in FIG. 2, it should be known that identical effect could be obtained with that of the embodiment shown in FIG. 1, because twice the magnetic pole number can be obtained, while the permanent magnets 121a, 121b, 121c are installed between the ferromagnetic substances 131a, 131b, 131c, 131d of the rotor 120 with skipping over the ferromagnetic substance.

For instance, when the permanent magnets 121a, 121b are installed between the ferromagnetic substance 131a and the ferromagnetic substance 131b, and between the ferromagnetic substance 131c and the ferromagnetic substance 131d, without installing a permanent magnet between the ferromagnetic substance 131b and the ferromagnetic substance 131c, twice the magnetic pole number is obtained to thereby achieve identical effect with that of the embodiment, because the ferromagnetic substance 131b and the ferromagnetic substance 131c are magnetized to be the S pole and the N pole due to the permanent magnets 121a, 121b positioned adjacently in the right and left directions.

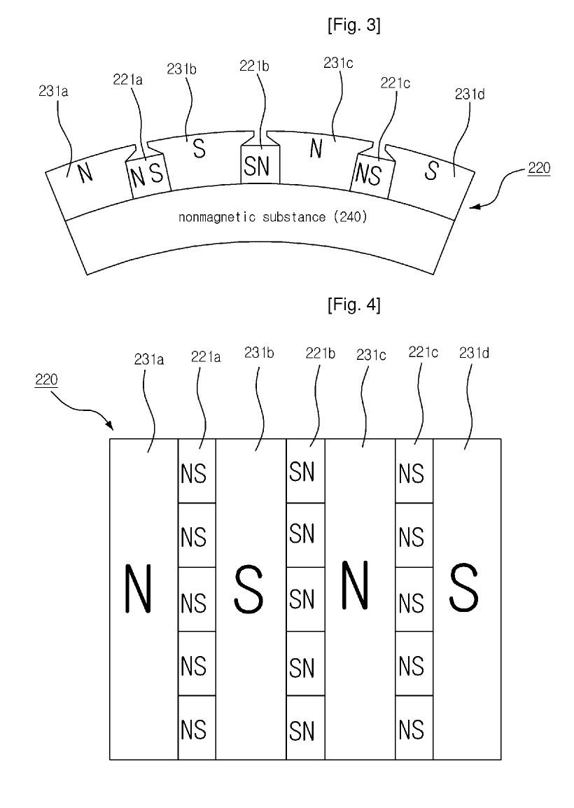

FIG. 3 is a schematic view showing a portion of the permanent magnet generator according to another embodiment of the present invention, and FIG. 4 is also a schematic view showing a permanent magnet generator according to another embodiment of the present invention, in which the magnet arrangement is schematically shown.

As shown in FIGS. 3 and 4, when a non-magnetic substance 240 is disposed at the axial direction of the rotor 220, and permanent magnets 221a, 221b, 221c of the same direction are disposed in series along the axial direction between the ferromagnetic substances 231a, 231b, 231c, 231d, the assembly work becomes easier as the repulsion force between the permanent magnets 221a, 221b, 221c become small. The action and effect of the above embodiment are the same as those of the above embodiment.

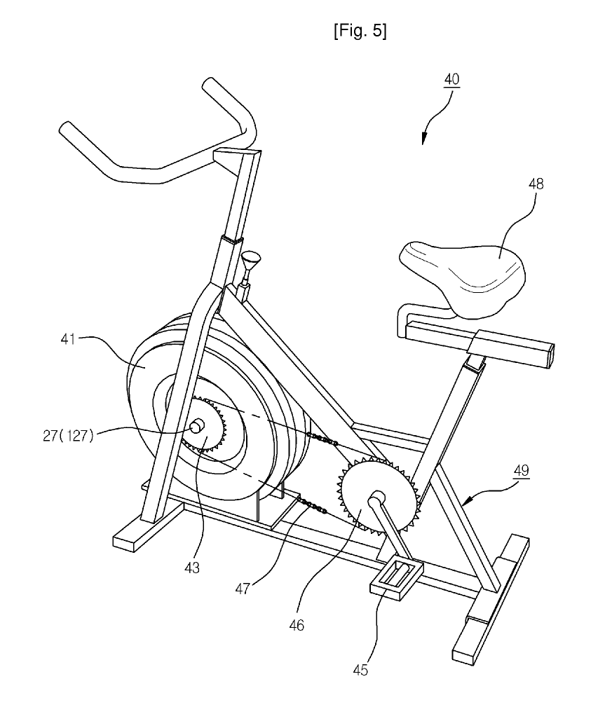

FIG. 5 is a view showing a use example of the permanent magnet generator according to the present invention. As shown in FIG. 5, the present invention can be applied to a bicycle type rotation means 40, 140, which is a kind of an exercising device so that required electric power can be produced.

In other words, when the stator 10 and the rotor 20, 120 are covered with a case 41 so that only a rotation shaft 27, 127 of the rotor 20, 120 is exposed, a sprocket 43 is installed to the exposed rotation shaft 27, 127, and the sprocket 43 is connected to a sprocket 48 with a pedal 45 by means of a chain 47, then, the rotor 20, 120 is adapted to be driven according to the treading movement of the pedal 45 by a user, who is sit on a saddle 48, so that electric power can be generated. The generation of the electric power can provide two simultaneous effects such that the users can exercise and obtain the electricity at the same time. The drawing numeral 49 represents a frame of the rotation means 40.

In addition, it is possible to produce necessary electricity by constructing that a handle knob is installed at the rotation shaft of the rotor 20, 120 so that the user can rotate the rotation shaft with grasping the handle knob, differently from the above embodiments.

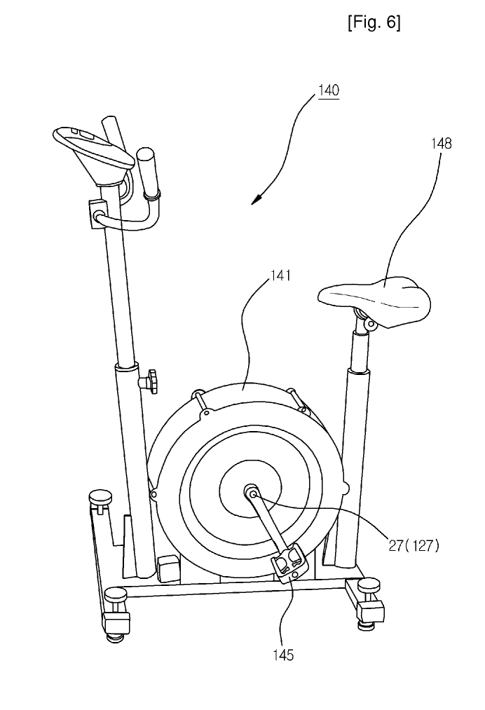

FIG. 6 is a view showing another use example of FIG. 5. As shown in FIG. 6, it is constructed that the stator 10 and the rotor 20, 120 are covered with a case 141 so that rotation shaft 27, 127 of the rotor 20, 120 is exposed, and a pedal 145 is directly installed to the exposed rotation shaft 27, 127, and the pedal 145 is treaded by the user sit on the saddle thereby rotating the rotor 20, 120 so that electricity can be generated.

### INDUSTRIAL APPLICABILITY

As described above, according to the present invention, it is possible to obtain an advantage of achieving the economic efficiency of obtaining larger capacity of generating the electric power by the structure of increasing the number of the magnetic poles more than twice because magnetized ferromagnetic substances are installed between the permanent magnets disposed at the rotor.

1. A permanent magnet generator comprising:
a rotor constructed by installing permanent magnets at an outer peripheral edge thereof while being spaced apart from each other by a predetermined interval so that identical magnetic poles of the permanent magnets face each other;
ferromagnetic substances, each of which is made of magnetizing metal substance and installed between the permanent magnets of the rotor so that they can be magnetized to be the same magnetic poles as those of the permanent magnets; and
a stator constructed to enclose the rotor by winding coils for inducting electric current between the ferromagnetic substances and the permanent magnets.

2. The permanent magnet generator according to claim 1, wherein non-magnetic substances are installed in the axial direction of the rotor, and the permanent magnets are arranged on the non-magnetic substances in series along the axial direction of the rotor.

3. The permanent magnet generator according to claim 1, further comprises a rotation means for rotating the rotor.

4. The permanent magnet generator according to claim 3, wherein the rotation means is a pedal installed at a shaft of the rotor so that it can be treaded with feet.

5. The permanent magnet generator according to claim 1, wherein the stator is further provided with a battery for accumulating the electricity produced from the coils.
